(19) United States
(12) Patent Application Publication
(10) Pub. No.: US 2025/0116588 A1
(43) Pub. Date: Apr. 10, 2025

(54) METHOD, DEVICE, USE AND INSTALLATION FOR GAS DENSITY MONITORING

(71) Applicant: Trafag AG, Bubikon (CH)

(72) Inventor: Halbheer REMO, Hinwil (CH)

(21) Appl. No.: 18/730,038

(22) PCT Filed: Jan. 10, 2023
(86) PCT No.: PCT/EP2023/050465

§ 371 Date: Jul. 18, 2024

(30) Foreign Application Priority Data
Jan. 18, 2022 (DE) 10 2022 101 105.4
Jan. 21, 2022 (DE) 10 2022 101 481.9

(51) Int. Cl. G01N 9/26

(52) U.S. Cl. CPC G01N 9/266; G01N 2009/263

(57) ABSTRACT

In order to mechanically monitor a gas density of a greenhouse gas in a more climate-friendly and cost-effective manner, the invention provides a density monitoring method for monitoring the gas density of a noxious gas (10), comprising: a) providing a closed reference volume (26) with a partition wall (28) movably disposed between the reference volume (26) and the noxious gas (10) to be monitored, b) providing a reference gas (56) which has a lower global warming potential relative to the noxious gas (10) by at least a factor of two in the reference volume (26) at a reference gas pressure which is higher than the filling pressure of the noxious gas (10), c) compensating, by means of a spring device (32), for a force acting on the separation wall (28) due to the increased reference gas pressure in the reference volume (26), and d) detecting a deflection of the partition wall (28) for monitoring the gas density. A gas density monitor (14), its use in such a method and an electrical system provided therewith are also proposed.

The invention relates to a density monitoring method for monitoring the gas density of a noxious gas. The invention also relates to a density monitor for monitoring the gas density of a noxious gas. The invention further relates to the use of a density monitor for monitoring a gas density of a noxious gas. Finally, the invention relates to an electrical installation with a closed space, such as a housing, a container or a tank, in which an insulating gas with an environmentally harmful effect (harmful gas) is contained, and with a density monitor for monitoring the gas density of the insulating gas.

For the technological background, reference is made to the following literature:
[1] “Insulating gas density monitoring”, brochure from Trafag AG with the print reference “H70558a Trafag AG 11/2021” [2]
[2] DE 10 2010 055 249 B4
[3] DE 10 2013 115 007 B4
[4] DE 10 2016 123 588 A1
[5] WO 2019/192857 A1
[6] Wikipedia “Treibhauspotential” downloaded on Jan. 20, 2022 from https://de.wikipedia.org/wiki/Treibhauspotential
[7] Website Novec Isoliergase 3M Deutschland, downloaded on Jan. 20, 2022 from https://www.3mdeutschland.de/3M/de_DE/novec-de/anwendungen/isoliergas/[8]
[8] “Powering a sustainable future. 3M™ Novec™ Insulating Gases”, brochure from 3M, downloaded on Jan. 20, 2022 from https://multimedia.3 m.com/mws/media/14086000/novec-insulating-gases-for-power-generation.pdf
[9] “sf6 ersatz g3 Flyer”, brochure downloaded on Jan. 20, 2022 from https://www.gegridsolutions.com/products/brochures/sf6-ersatz_g3-flyer-ger.pdf
[10] DE 10232823 A1

Density monitors are devices, in particular measuring devices, for monitoring the gas density of a gas to be monitored. As is known from [1] to [5], density monitors are used in particular to monitor the density of a gas, for example SF6, which is present as an insulator in gas-insulated high and medium voltage systems, such as high-voltage switchgear, transformers, pipelines, switching devices, and transformers.

Density monitors based on electronic measuring principles are known for this purpose, for example from [10]. These are equipped with an electronic density sensor as a transducer which has an oscillating quartz arranged in the gas and supplies a frequency signal proportional to the density of the gas as a measured value, and the frequency signal is fed to an electronic evaluation unit.

On the other hand, density monitors based on mechanical measuring principles have become established on the market. Due to their mechanical measuring principle, they work very reliably and require little maintenance, even over very long periods of time. In the simplest and most common case, a partition wall operating on the basis of a reference volume is in communication with the measuring volume, and a partition wall movement caused by a change in gas density actuates a switch. In density monitors known from [1] to [5], for example, a partition wall of a metal bellows is connected to a switch so that a partition wall movement beyond a minimum distance triggers a switching operation.

The invention is based on the problem of making density monitors working on a mechanical measuring principle with a reference volume more environmentally friendly.

To solve this problem, the invention provides a density monitoring method according to claim 1 as well as a density monitor, a use, and an electrical system according to the independent claims.

Advantageous embodiments are the subject of the subclaims.

According to a first aspect thereof, the invention provides a density monitoring method for monitoring the gas density of a noxious gas, comprising:
a) providing a closed reference volume with a partition wall arranged between the reference volume and the noxious gas to be monitored,
b) providing a reference gas the global warming potential of which is lower by at least a factor of two relative to the noxious gas in the reference volume with a reference gas pressure which is increased compared to the noxious gas pressure of the noxious gas,
c) compensating, by means of a spring device, for a force acting on the partition wall as a result of the increased reference gas pressure in the reference volume, and
d) detecting a deflection of the partition wall for monitoring the gas density.

According to a further aspect thereof, the invention provides a density monitor for monitoring a gas density of a noxious gas, comprising:
a measuring volume,
a connection for connecting the measuring volume to a space containing the noxious gas,
a closed reference volume which is filled with a reference gas which differs from the noxious gas to be monitored and which has a global warming potential GWP<100,
where GWP denotes the CO2-equivalent in relation to 100 years according to IPCC AR5, the reference gas being filled with an overpressure compared to the pressure in the measuring volume during the intended operation of the density monitor,
a partition wall separating the reference volume from the measuring volume,
a partition wall deflection detection device for detecting a deflection of the partition wall, and a spring device for elastically exerting a force on the partition wall to compensate for the overpressure in the reference volume.

According to a further aspect thereof, the invention provides a use of a density monitor for monitoring a gas density of a noxious gas, wherein the density monitor comprises a measuring volume, a connection for connecting the measuring volume to a space containing the noxious gas,
a closed reference volume,
a partition wall separating the reference volume from the measuring volume and a partition wall deflection detection device for detecting a deflection of the partition wall and at least one spring device for elastically exerting a force on the partition wall,
wherein the reference volume contains a reference gas which is different from the noxious gas to be monitored and which has a global warming potential GWP<100, where GWP denotes the CO2-equivalent in relation to 100 years according to IPCC AR5, with a reference gas pressure which is greater than a noxious gas pressure in the measuring volume,
wherein a force acting on the partition wall due to the increased reference gas pressure in the reference volume is compensated by means of the spring device.

According to a further aspect thereof, the invention provides an electrical system comprising a space filled with an insulating gas as a noxious gas and a density monitor which is connected to the space for monitoring the gas density of the noxious gas, wherein the density monitor comprises a measuring volume which is connected to the space, a closed reference volume which is filled with a reference gas which is different from the noxious gas to be monitored, which reference gas has a global warming potential GWP<100, where GWP denotes the CO2-equivalent in relation to 100 years according to IPCC AR5, and has an overpressure compared to the noxious gas pressure prevailing in the space, a partition wall which separates the reference volume from the measuring volume, a partition wall deflection detection device for detecting a deflection of the partition wall, and at least one spring device for elastically exerting a force on the partition wall in order to compensate for the overpressure in the reference volume.

A preferred embodiment of at least one of the aspects of the invention comprises:
b1) providing a gas with a GWP<100, preferably GWP<20, more preferably GWP>2, where GWP denotes the CO2-equivalent in relation to 100 years according to IPCC AR5, as a reference gas in the reference volume.

A preferred embodiment of at least one of the aspects of the invention comprises:
b2) providing a gas from the group comprising air, N₂, O₂, noble gases, Ar, Kr, He, CO₂ and mixtures of the aforementioned gases with one another or with a further gas as the reference gas in the reference volume.

A preferred embodiment of at least one of the aspects of the invention comprises: providing the reference gas with a reference gas pressure that is 2.5-45% higher than the noxious gas pressure in the reference volume.

A preferred embodiment of at least one of the aspects of the invention comprises:
c1) applying a first spring force of the spring device acting in the direction of the reference volume to the partition wall to compensate for the force caused by the increased reference gas pressure.

For example, the spring device has a first spring for exerting the first spring force. The first spring is preferably designed as a first compression spring which acts on the noxious gas side of the partition wall and urges it in the direction of the reference volume.

A preferred embodiment of at least one of the aspects of the invention comprises:
c2) applying a second spring force to the partition wall acting in the direction of the noxious gas to extend the monitorable range of gas density.

For example, the spring device has a second spring for exerting the second spring force. The second spring is preferably designed as a second compression spring acting on the partition wall from the reference volume side.

A preferred embodiment of at least one of the aspects of the invention comprises: adjusting the first spring force depending on the noxious gas pressure and/or the reference gas pressure. In particular, the preferred embodiment of the invention comprises selecting the spring constant of the first spring as a function of the noxious gas pressure and/or the reference gas pressure.

A preferred embodiment of at least one of the aspects of the invention comprises: adjusting the second spring force according to a desired gas pressure for at least one desired gas density value or gas density range for at least one switching point or switching range. In particular, the second aspect comprises selecting the spring constants of the first and/or the second spring according to a desired gas density value or gas density range for at least one switching point or switching range.

A preferred embodiment of at least one of the aspects of the invention comprises: selecting a preload of at least one spring of the spring device according to a desired gas density value or gas density range for at least one switching point or switching range.

A preferred embodiment of at least one of the aspects of the invention comprises: limiting the effectiveness of at least one spring of the spring device to a partial range of the deflection travel of the partition.

A preferred embodiment of at least one of the aspects of the invention comprises: limiting the effectiveness of the first spring to a range below a predetermined gas density threshold.

According to a preferred embodiment of at least one of the aspects of the invention, a metal bellows is or will be provided for separating the reference volume from a measurement volume containing the noxious gas, wherein the partition wall is formed on the metal bellows.

Preferably, the reference gas is selected from the group comprising air, N₂, O₂, noble gases, Ar, Kr, He, CO₂ and mixtures of the aforementioned gases with one another or with another gas.

In a preferred embodiment of at least one of the aspects of the invention, a first spring acting on the partition wall in the direction towards the reference volume for compensating the force caused by overpressure and a second spring acting on the partition wall in the direction towards the noxious gas for extending the monitorable range of the gas density are or will be provided.

Preferably, the use according to the invention or an advantageous embodiment thereof serves to carry out the method according to the invention or an advantageous embodiment thereof.

Preferably, the density monitor according to the invention or an advantageous embodiment thereof is designed to carry out the method according to the invention or an advantageous embodiment thereof. Preferably, the method according to the invention or an advantageous embodiment thereof is carried out with a density monitor according to the invention or an advantageous embodiment thereof.

Preferably, the method according to the invention or an advantageous embodiment thereof is carried out on an electrical installation of the invention or an advantageous embodiment thereof.

Features or steps disclosed for one of the aspects of the invention-method, apparatus, use, installation—or advantageous embodiments thereof may also be provided for one of the other aspects of the invention or advantageous embodiments thereof.

Advantageous embodiments of the invention relate to density monitors with gases having a low greenhouse effect, in particular density monitors with green or climate-neutral gases, as well as uses thereof, such as density monitoring methods to be carried out therewith. Preferred embodiments of the invention relate to mechanically operating density monitors without SF6, which are designed to monitor the density of SF6.

In particular, a density monitor based on the reference chamber principle (mechanical measuring principle) is provided. Preferably, the density monitor is used for monitoring the gas density in high-voltage switchgear (gas-insulated switchgear, outdoor switchgear, “dead tanks”) in order to avoid damaging arcs and to ensure the safety of the systems over long periods of time (e.g. 30 years). A temperature-compensated pressure switch is a special design example of a density monitor. The temperature compensation is achieved in particular via a reference volume that is thermally connected to the gas to be monitored.

As is also known from [1] to [5], a density monitor or a temperature-compensated pressure switch of this type measures against a reference volume. In previously known density monitors of this type, the reference volume must be filled gas-tight with the same gas to be measured as the gas to be monitored at approximately the same pressure as the system pressure. This means that known density monitors of this type have to be filled with greenhouse gases such as SF6, some of which are harmful to the environment. Until now, the same insulating gas used by the system manufacturer must be used for sufficient temperature compensation. The gas chamber (system gas) and the reference volume are separated from each other by a metal bellows, for example. A density and pressure difference between the gas chambers leads to a mechanical stroke of the metal bellows. This gas (SF6) is a greenhouse gas with a very high GWP (>10′000) and is subject to increasingly strict environmental laws, see reference [6] for more information. The gas behavior and the function of the density monitor are described in detail in reference [1], which is referred to for further details.

According to preferred embodiments, the density monitor is a purely mechanically operating density monitor, which is typically delivered with two to four switching points (for example switching point 1=alarm 640 kPa, switching point 2=refill procedure required 620 kPa and switching point 3=emergency shutdown 600 kPa). The switching point thresholds lie on so-called isochores so that a pure temperature effect does not lead to a false alarm. The optimum filling pressure in the reference volume would be 620 kPa for previously known density monitors in this example, the errors for the other two switching points would be a few kPa for a temperature range of −25° C. and 50° C.

For good temperature compensation (for example, outdoor use between −60° C. and +60° C. is possible), the reference gas chamber principle requires the internal reference volume to be filled with the identical system gas. Traditionally, SF6, CF4 with N2 and mixtures thereof are used in high-voltage technology for liquefaction. For some years now, less environmentally harmful substitute gases have also been on the market, which already cause significantly lower GWP, see references [7] to [9]. Nevertheless, a large number of systems worldwide continue to be filled with SF6, just like the reference chamber systems of the density monitors used. In addition, the substitute gases, which must also be filled into the reference chamber in previous density monitors with the reference volume principle, still have a very high global warming potential.

Preferred embodiments of the invention use any less climate-damaging or more preferably climate-neutral gases (i.e. gases without a greenhouse effect) such as N₂, Kr or Ar as filling gases for the reference chamber. In order to achieve the same isochore (specified in kPa/° C.) as SF6 (or another greenhouse gas used as an insulating gas), the chamber is overfilled. In particular, an approx. 3-40% higher filling pressure is used, e.g. to simulate the required filling pressures between 1 and 12 bar SF6. The reference gas (e.g. climate-neutral gas, i.e. not a greenhouse gas) is thus preferably filled at a pressure of between 1.5 and 20 bar.

In a preferred embodiment, gases that are widely and inexpensively available on the market, such as technical air, N₂, Ar or CO₂, are used as the reference gas. Although CO₂ is known as a greenhouse gas, with its GWP=1 it is far more climate-friendly than the system gases to be monitored. Other noble gases are also possible or can be added. For example, the reference chamber can be filled and welded for gas-tight sealing under an inert gas atmosphere that already corresponds to the subsequent atmosphere in the reference chamber.

Preferably, the density monitor has a filling opening for filling the reference volume and/or for changing the composition or pressure of the reference pressure.

In order to achieve comparable accuracies and the switching point distances of the density monitor comparable to previous mechanical density monitors working on the reference volume principle, it is preferable to partially compensate for the higher force of the gas pressure spring.

In preferred embodiments of the invention, at least two additional springs are used to compensate for this force effect.

A first spring is used to compensate for the force of the reference chamber. The first spring exerts a first elastic force directly or indirectly on the partition wall in the direction of the reference volume. For example, the first spring-if designed as a compression spring-acts on the partition wall from the noxious gas side, e.g. from the side of the measuring volume.

The first spring is preferably selected depending on the pressure and has spring constants between 15 and 140 N/mm, for example, at 1 and 12 bar filling pressure.

A second spring exerts a second elastic force on the partition wall in the opposite direction to the first elastic force. In particular, the second spring exerts a second elastic force directly or indirectly on the partition wall in the direction of the noxious gas. If designed as a compression spring, the second spring is located in the reference volume, for example, and acts on the partition wall from the reference volume side.

The second spring preferably has a spring constant of approximately 20-30 N/mm. The second spring serves for the area expansion of the reference chamber. This makes it possible, for example, to achieve widely spaced switching points or an extended display range.

By selecting or setting the different spring constants of the first and second springs, their preload and/or their effective travel, the density monitor can be adapted to the prevailing pressures, desired switching points or display ranges and the noxious gas.

To adjust the effective travel, for example, at least one stop can be provided which limits the effect of at least one of the springs to one or more specific regions of the deflection travel of the partition wall.

Preferred embodiments of the invention provide a temperature-compensated density monitor without the use of an environmentally harmful gas (“green gas” density monitor).

Preferred embodiments provide a density monitor for high and medium voltage switchgear using green gas (e.g. nitrogen, argon, helium . . . ) with temperature compensation.

An adaptation of an isochore gradient to the customer gas-system gas, insulating gas, noxious gas—is preferably achieved by overfilling the reference chamber with green gas. This additional force of the gas spring can then be compensated by means of spring force.

Preferred embodiments use a noble gas as the reference gas. For example, argon gas (green gas) makes it possible to close the reference chamber without an additional component such as an expander or ball and under pressure (argon gas).

In a preferred embodiment, the force compensation by a spring device or at least one spring thereof is limited to a part of the measuring range. For example, the first spring is only effective for the low pressure range. Preferably, the first spring is only in use up to the lowest switching alarm; this arrangement achieves a more accurate switching point, as the spring is no longer in use at the switching points.

In preferred embodiments, different pressure ranges can be realized through the interaction of spring forces and the reference force—i.e. force due to the reference gas pressure in the reference volume. Depending on the desired pressure range, the spring forces as well as the preload of the first and second spring elements can be designed accordingly.

The spring device can be designed in different ways. For example, it can be designed as a spring arrangement with at least one or preferably several springs. The term “spring” refers to an elastically deformable machine element for exerting a spring force. A spring can be formed by one spring element or several spring elements acting in parallel and/or in series. Springs or spring elements can be e.g. helical springs, gas springs, rubber springs, elastomer blocks, leaf springs, torsion springs, bending springs, spring washers, conical springs, etc. Metallic springs, in particular helical compression springs, are preferred.

An exemplary embodiment is described in more detail below with reference to the attached drawings.

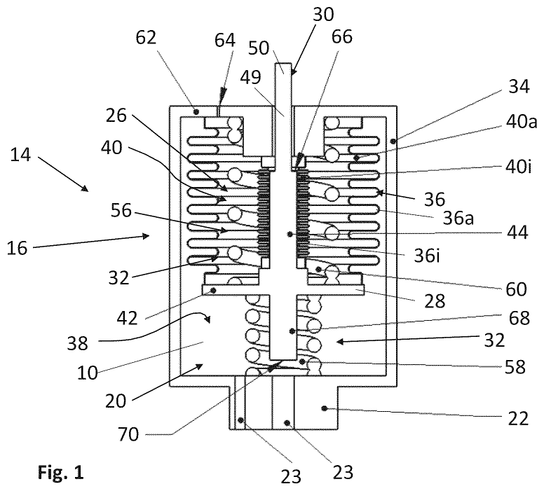

FIG. 1 shows a section through a measuring sensor of a density monitor according to one embodiment of the invention;

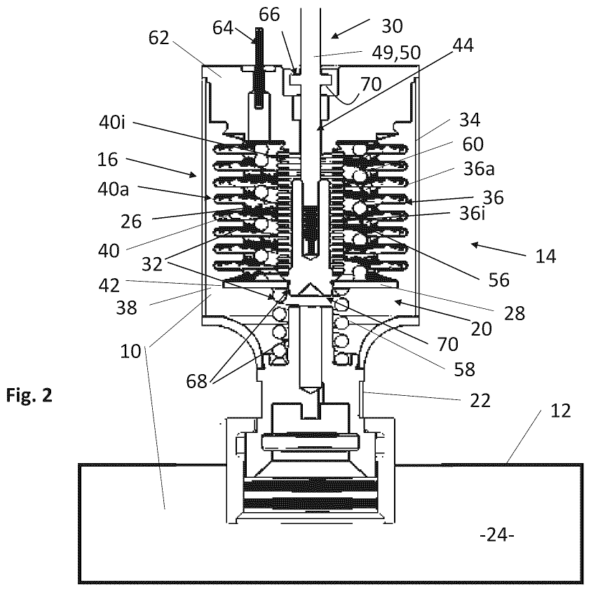

FIG. 2 a section through a lower part of a density monitor connected to an electrical system according to a further embodiment of the invention;

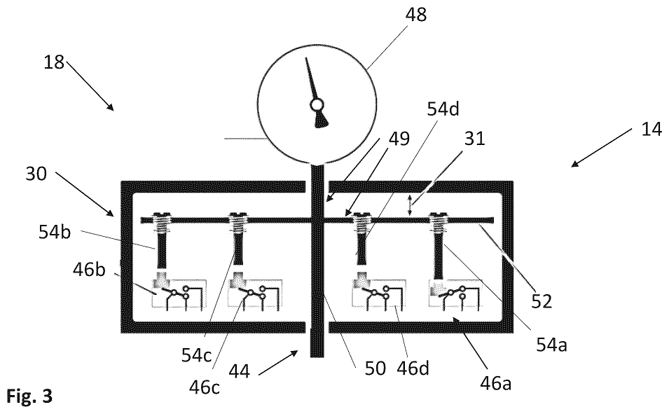

FIG. 3 a section through the upper part of the density monitor of FIG. 2.

The Figures show different embodiments of a density monitor 14 to be connected to an electrical system 12 filled with noxious gas 10, wherein FIG. 1 shows a measuring sensor 16 of the density monitor 14 according to one embodiment to illustrate the principle of operation. FIG. 2 shows the connection of the measuring sensor 16 of the density monitor according to a further embodiment to the system 12, and FIG. 3 shows an embodiment of a switching and/or display part 18 of the density monitor 14 which can be connected to the measuring sensor 16 according to one of the embodiments.

The electrical system 12 is, in particular, a gas-insulated high-voltage or medium-voltage system, such as a high-voltage or medium-voltage switchgear, a high or medium-voltage transformer, a high or medium-voltage pipeline, a high or medium-voltage switching device or a transformer. For gas insulation, a space 24 of the electrical system 12 is filled with an insulating gas. Such insulating gases are greenhouse gases with a high global warming potential GWP and are therefore harmful gases for the climate. For example, the noxious gas 10 used as an insulating gas in the system 12 is one of the gases SF6, CF4 with N2, a mixture thereof or an SF6 substitute gas as explained in more detail in references [7] to [9]. The pressure under which the noxious gas 10 is present in the space 24 is referred to below as the noxious gas pressure. This pressure (e.g. pressure SF6) is predetermined by the system as a predetermined filling pressure.

The density monitor 14 is used to monitor the gas density of the noxious gas 10. It has the measuring sensor 16, which is designed as a sensor for the system gas.

According to the embodiments shown in the Figures, the density monitor 14 has a measuring volume 20, a connection 22 for connecting the measuring volume 20 to the space 24 of the electrical system 12 containing the noxious gas 10, a closed reference volume 26, a movable or deflectable partition wall 28 which separates the reference volume 26 from the measuring volume 20, a partition wall deflection detection device 30 for detecting a deflection 31 of the partition wall 28, and a spring device 32.

The connection 22 is designed as a pressure connection for pressure-tight and fluid-tight connection of the measuring volume 20 to the space 24 of the system 12. At least one gas feedthrough 23 to the system 12 is formed in the connection 22. In the illustrated embodiment, the connection 22 has several gas feedthroughs 23.

To form the measurement volume 20 and the reference volume 26, in preferred embodiments, the interior of a housing 34 of the measuring sensor 16 is divided into several chambers by means of at least one metal bellows 36. A measuring chamber 38 communicating with the connection 22 forms the measuring volume 20, from which a reference chamber 40 for forming the reference volume 26 is separated by the metal bellows 36 or one of several metal bellows 36a. The partition wall 28 is formed on this metal bellows 36, 36a. For example, the partition wall 28 is formed by a bellows bottom 42 of this metal bellows 36, 36a.

In the embodiment shown, the reference chamber 40 is formed between a plurality of metal bellows 36a, 36i. An outer metal bellows 36a with the partition wall 28 separates the reference chamber 40 from the measuring volume 20. An inner metal bellows 36i separates the reference chamber 40 from the switching and display part 18.

The partition wall deflection detection device 30 detects a movement or deflection 31 of the partition wall 28 that is caused by a change in the noxious gas pressure relative to the pressure in the reference volume 26. The fact that the reference volume 26 is in thermal contact with the measuring volume 20 and thus also with the noxious gas 10 results in temperature compensation. The reference chamber principle, as explained in detail in reference [1], can therefore be used to measure the gas density via the deflection 31 of the partition wall.

The partition wall deflection detection device 30 has a transmission element 44 for transmitting the deflection of the partition wall 28 to switching or display elements 46a-46d, 48 of the switching and/or display part 18. The transmission element 44 can be, for example, a switching rod connected to the partition wall 28 for joint movement. The switching rod 49 has a plunger 50 and a cross rod 52 with arms 54a-54d of different lengths. This allows different (e.g. first to fourth) switching elements 46a-46d to be switched to different positions of the deflection of the partition wall 28—and thus to different gas density values (switching points)—for example in order to emit different alarms or switch-off signals. In addition, the plunger 50 can drive a customized display

An upper stop 66 is arranged on the switching rod 49 to limit a movement of the partition wall 28 if the pressures in the measuring volume are too high.

While the density monitors from references [1] to [5] have a reference chamber filled with the same gas and at the same pressure as in the system 12, the reference volume 26 in the embodiments of the invention is filled with a reference gas 56 that differs from the noxious gas 10 and that has a significantly lower global warming potential than the noxious gas 10. For example, the GWP of the reference gas 34 is lower than the GWP of the noxious gas 10 to be monitored by a factor of more than two.

In particular, gases with a GWP<100, preferably GWP<20, particularly preferably GWP<2 are used as the reference gas. Gases that are widely available on the market at low cost, such as technical air or compressed air, N₂, O₂, Ar or CO₂, are particularly preferred, while CO₂ with a global warming potential GWP=₁ is still significantly more climate-friendly than any insulating gas. In other designs, noble gases such as Ar, Kr, He are used. In particular, if welding shield gases such as Ar, Kr are used, the reference chamber 40 can be sealed in a gas-tight manner by welding immediately during filling.

As known from [1], the gas density is measured along isochores.

For the approximation of the isochore gradients of the reference gas and the noxious gas to be monitored, the reference gas 56 is filled into the reference chamber 40 with an overpressure compared to the specified system filling pressure-noxious gas filling pressure. The overpressure is e.g. 2.5%-45%. Thus, the reference gas pressure is 2.5%-45%, preferably 3% to 40%, higher than the noxious gas pressure.

Exemplary values for different system filling pressure values of SF6 as the gas to be monitored and N₂ with 5% He as the reference gas are shown in Table 1.

TABLE 1

| SF6 | N2 Filling | |
|---|---|---|
| Filling | pressure incl. 5% | Isochore gradient |
| pressure kPa | helium kPa | in kPa/° C. |
| 100 | 103 | 0.35 |
| 200 | 211 | 0.72 |
| 300 | 324 | 1.11 |
| 400 | 442 | 1.52 |
| 500 | 567 | 1.96 |
| 600 | 699 | 2.41 |
| 700 | 839 | 2.90 |
| 800 | 981 | 3.42 |
| 900 | 1135 | 3.96 |
| 1000 | 1296 | 4.54 |
| 1100 | 1466 | 5.15 |

In one possible embodiment, the reference chamber 40 is preferably prefabricated as a separate construction unit during the manufacture of the density monitor 14 by gas-tight connection of the inner and outer metal bellows 36a, 36i and then installed in the housing 34. In the embodiments shown in FIGS. 1 and 2, the reference chamber 40 is characterized by an inner bellows 40i, the bellows base 42, an outer bellows 40a and a flange cover 62, which is part of the housing 34 of the measuring sensor 16 (also called sensor system). The bellows 40a, 40i are designed as metal bellows 36a, 36i and are connected to the flange cover 62 in a fluid-tight manner by their edges shown in the Figures above. A filling hole 62 is provided on the flange cover for filling the reference chamber 40. Thus, the density monitor has a filling device for filling the reference chamber 40 and/or for exchanging the reference gas or for changing the reference gas pressure. This allows the reference gas pressure to be adapted to a change in the filling pressure in the system 12 so that the overpressure in the reference chamber 40 can be adjusted relative to the filling pressure in the system 12.

The spring device 32 is provided to compensate for at least some effects that occur due to the use of the climate-friendly reference gas in the reference chamber instead of the noxious gas to be monitored for temperature compensation.

Due to the increased reference gas pressure compared to the noxious gas pressure, the gas spring formed from the filled metal bellows 36 exerts a greater force than in conventional density monitors. The spring device 32 is designed in particular to compensate for this force due to the overpressure.

In the embodiments shown, the spring device 32 has a first spring 58 for exerting a first spring force on the partition wall 28 in the direction of the reference gas. The first spring force serves to compensate for the force acting on the partition wall 29 due to the overpressure in the reference volume 26.

The first spring 58 is selected depending on the filling pressure and, in a configuration according to the measuring sensor 16 as shown in the Figures with the typical dimensions resulting from [1] and the reference gas according to Table 1, for example, has a spring constant with a value between 15 N/mm at 1 bar filling pressure and 140 N/mm at 12 bar filling pressure. The first spring 58 is used for force compensation of the reference chamber. In general, the spring constant must be selected depending on the respective measuring sensor, in particular the area of the partition wall or the other pressurized surfaces. Suitable values can easily be found using the example given and the explanations given in [1] by means of simple trials.

In the illustrated embodiment, the first spring 58 is designed as a compression spring, is arranged on the contact side of the separating diaphragm 28, i.e. for example in the measuring volume 20, and exerts the first spring force on the side of the separating wall 28 facing the system 12 or the measuring volume 20. A spring guide 68 for guiding the first spring 58 is attached to the partition wall 28, for example in the form of a pin-shaped projection projecting from the bellows base 42. The free end of the projection of the spring guide 68 serves as a lower stop 70 for limiting the movement of the partition wall 28 towards the measuring volume 20.

Furthermore, the spring device 32 has a second spring 60 for exerting a second spring force on the partition wall 28 in the direction of the measuring volume 20 or the noxious gas 10. The second spring 60 allows the measuring range to be extended. In the embodiments described here, the second spring 60 has a spring constant of approximately 20-30 N/mm with the reference gas and the filling values of Table 1 and the typical dimensions of reference [1]. The second spring 60 serves for the area extension of the reference chamber 40 so that, for example, widely spaced switching points or an extended display range can be created.

In the embodiment shown, the second spring 60 is also designed as a compression spring and is arranged in the reference chamber 40 on the side of the partition wall 28 facing the reference chamber 40 and is used to set the switching point(s) or display range.

By selecting and/or adjusting the spring constants and any preloads of the springs 58, 60 of the spring device 32, the measuring sensor 16 can be set to predetermined pressures, measuring ranges and switching points or switching ranges.

Furthermore, the effective travel of at least one of the springs, e.g. the first spring 58, can be limited by means of at least one stop (not shown).

In one example, the first spring 58 only acts for the low pressure range. For example, the first spring is only in use up to the lowest switching alarm and then strikes against the stop, which is stationary relative to the housing 34 so that the partition wall 28 moves free of the first spring force in the remaining effective range. This arrangement achieves a more precise higher switching point, as the first spring is no longer in use at the other switching points.

The density monitor 14 can be used to carry out a density monitoring method for monitoring the gas density of the noxious gas 10, comprising the steps:
a) providing a closed reference volume 26 with a partition wall 28 arranged between the reference volume 26 and the noxious gas 10 to be monitored,
b) providing a reference gas 56 which has a lower global warming potential relative to the noxious gas 10 by at least a factor of two in the reference volume 26 with a gas pressure which is increased compared to the filling pressure of the noxious gas 10,
c) compensating, by means of at least one spring device 32, a force acting on the partition wall 28 due to the increased reference gas pressure in the reference volume 26, and
d) detecting a deflection of the partition wall 28 for monitoring the gas density.

Further embodiments for the method, the density monitor 14 as well as its uses and the system 12 result from the application of the measures explained here for filling a reference volume 26 with more climate-friendly reference gas 56 and compensation of disadvantages due to the deviation of reference gas 56 and noxious gas 10 to be monitored by higher pressure in the reference chamber 40 and compensation of forces by the spring device 32 on the density monitors working with reference volumes which are described and shown in references [1] to [5]. Reference is therefore expressly made to references [1] to [5] for further possible features of embodiments of the density monitors 14 according to the invention and their uses.

With preferred embodiments of the density monitoring method, even a very climate-damaging greenhouse gas such as SF6 can be monitored for its gas density in a mechanical and temperature-compensated manner without requiring such a climate-damaging gas for the production and operation of the density monitor 14 itself. In addition to the environmental aspect, due to the use of climate-friendly gases as reference gases, the costs for the manufacture, transportation, assembly and installation of the density monitor 14 can also be significantly reduced, as no safety measures are required for noxious gases and far less expensive gases can be used as reference gases.

Any disadvantages with regard to the accuracy and the usual spread of switching points or displays are eliminated by means of a spring device 32 which preferably operates purely mechanically with simple springs.

According to some embodiments not shown in detail, the spring device 32 can have an adjustment device for changing at least one force parameter of the spring device 32. For example, the spring device 32 has a preload adjustment device for adjusting a preload of at least one of the springs 58, 60, such as in particular the second spring 60. In particular, this allows the display range and at least one or some of the switching points or their distance (with respect to the gas density) from one another to be set.

In order to monitor a gas density of a greenhouse gas mechanically in a more climate-friendly and cost-effective manner, a density monitoring method for monitoring the gas density of a noxious gas (10) is proposed, comprising:
a) providing a closed reference volume (26) with a partition wall (28) movably arranged between the reference volume (26) and the noxious gas (10) to be monitored,
b) providing a reference gas (56) which has a lower global warming potential relative to the noxious gas (10) by at least a factor of two in the reference volume (26) at a reference gas pressure which is increased compared to the filling pressure of the noxious gas (10),
c) compensating, by means of a spring device (32), for a force acting on the partition wall (28) due to the increased reference gas pressure in the reference volume (26), and
d) detecting a deflection of the partition wall (28) for monitoring the gas density.

A gas density monitor (14), its use in such a method and an electrical system (12) provided therewith are also proposed.

### LIST OF REFERENCE SIGNS

10 noxious gas
12 electrical system
14 density monitor
16 measuring sensor
18 switching and/or display unit
20 measuring volume
22 connection
23 gas feedthrough to the system
24 space (gas space of the electrical system)
26 reference volume
28 partition wall
30 partition wall deflection detection device
31 deflection
32 spring device
34 housing of the measuring sensor
36 metal bellows
36a outer metal bellows
36i inner metal bellows
38 measuring chamber
40 reference chamber
40a outer bellows (reference chamber)
40i inner bellows (reference chamber)
42 bellows base (partition wall-reference chamber)
44 transmission element
46a first switching element
46b second switching element
46c third switching element
46d fourth switching element
48 display
49 switching rod
50 plunger
52 cross rod
54a first arm
54b second arm
54c third arm
54d fourth arm
56 reference gas
58 first spring
60 second spring
62 flange cover
64 filling opening (reference chamber)
66 upper stop
68 spring guide
70 lower stop

1. A density monitoring method for monitoring the gas density of a noxious gas, comprising:
a) providing a closed reference volume having a partition wall movably disposed between the reference volume and the noxious gas to be monitored,
b) providing a reference gas which has a lower global warming potential relative to the noxious gas by at least a factor of two in the reference volume at a reference gas pressure which is increased compared to the filling pressure of the noxious gas,
c) compensating, by means of a spring device, for a force acting on the partition wall due to the increased reference gas pressure in the reference volume, and
d) detecting a deflection of the partition wall for monitoring the gas density.

2. The density monitoring method according to claim 1, characterized in that step b) includes at least one of the steps:
b1) providing a gas with a GWP<100, where said GWP denotes the CO2-equivalent in relation to 100 years according to IPCC AR5; or
b2) providing a gas from the group consisting of air, N₂, O₂, noble gases, Ar, Kr, He, CO₂, a mixture of at least two of the aforementioned gases with one another, and a mixture which is essentially formed from one or more of the aforementioned gases with an admixture of a further gas, as reference gas.

3. The density monitoring method according to claim 1, characterized in that step b) comprises:
providing the reference gas with a reference gas pressure that is 2.5-45% higher than the filling pressure of the noxious gas.

4. The density monitoring method according to claim 1, further comprising:
c1) applying to the partition wall a first spring force of the spring device acting in the direction of the reference volume to compensate for the force caused by the increased reference gas pressure, and
c2) applying to the partition wall a second spring force acting in the direction of the noxious gas to extend the monitorable range of the gas density.

5. The density monitoring method according to claim 4, characterized by at least one of the steps:
5.1 selecting the first spring force as a function of the filling pressure of the noxious gas and/or the reference gas pressure;
5.2 selecting a spring constant of a first spring of the spring device, which exerts the first spring force, as a function of the filling pressure of the noxious gas and/or the reference gas pressure;
5.3 adjusting the second spring force in accordance with a gas density value or gas density range desired for at least one switching point or switching range;
5.4 selecting the spring constants of a first spring of the spring device exerting the first spring force and/or of a second spring of the spring device exerting the second spring force in accordance with a gas density value or gas density range desired for at least one switching point or a display range,
5.5 selecting a preload of at least one spring of the spring device in accordance with a gas density value or gas density range desired for at least one switching or display range,
5.6 limiting the effectiveness of at least one spring of the spring device to a partial range of the deflection travel of the partition wall; or
5.7 limiting the effectiveness of a first spring of the spring device exerting the first spring force to a range below a predetermined gas density threshold.

6. The density monitoring method according to claim 1, characterized in that in step a) a metal bellows is provided for separating the reference volume from a measuring volume containing the noxious gas, wherein the partition wall is formed on the metal bellows.

7. A density monitor for monitoring a gas density of a noxious gas, comprising:
a measuring volume,
a connection for connecting the measuring volume to a space containing the noxious gas,
a closed reference volume which is filled with a reference gas which is different from the noxious gas to be monitored and which has a global warming potential GWP<100, where said GWP denotes the CO2-dequivalent in relation to 100 years according to IPCC AR5, the reference gas being filled during the intended operation of the density monitor with an overpressure compared with a standard pressure of the noxious gas or a filling pressure of the noxious gas,
a partition wall which separates the reference volume from the measuring volume,
a partition wall deflection detection device for detecting a deflection of the partition wall, and
a spring device for elastically exerting a force on the partition wall in order to compensate for the overpressure in the reference volume.

8. The density monitor according to claim 7, characterized in that the reference gas is selected from the group consisting of air, N₂, O₂, noble gases, Ar, Kr, He, CO₂, a mixture of at least two of the aforementioned gases with one another, and a mixture which is essentially formed from one or more of the aforementioned gases with an admixture of a further gas.

9. The density monitor according to claim 7, characterized in that the spring device comprises a first spring acting on the partition wall in the direction towards the reference volume for compensating the force caused by overpressure and a second spring acting on the partition wall in the direction towards the measuring volume for extending the monitorable range of the gas density.

10. Use of a density monitor for monitoring a gas density of a noxious gas, the density monitor comprising:
a measuring volume,
a connection for connecting the measuring volume to a space containing the noxious gas,
a closed reference volume,
a partition wall which separates the reference volume from the measuring volume,
a partition wall deflection detection device for detecting a deflection of the partition wall, and
a spring device for elastically exerting a force on the partition wall,
wherein the reference volume contains a reference gas which is different from the noxious gas to be monitored and which has a global warming potential GWP<100, where said GWP denotes the CO2-equivalent in relation to 100 years according to IPCC AR5, with a reference gas pressure which is greater than a filling pressure of the noxious gas, and
wherein a force acting on the partition wall due to the reference gas pressure increased compared to the filling pressure of the noxious gas in the reference volume is compensated by means of the spring device.

11. The use according to claim 10, characterized in that the reference gas is selected from the group consisting of air, N₂, O₂, noble gases, Ar, Kr, He, CO₂, a mixture of at least two of the aforementioned gases with one another, and a mixture which is essentially formed from one or more of the aforementioned gases with an admixture of a further gas.

12. The use according to claim 10, characterized in that the spring device comprises a first spring acting on the partition wall in the direction towards the reference volume to compensate for the force caused by overpressure and a second spring acting on the partition wall to extend the monitorable range of the gas density.

13. (canceled)

14. An electrical system, comprising a space filled with a noxious gas as an insulating gas with a predetermined filling pressure and the density monitor according to claim 7, which is connected to the space for monitoring the gas density of the noxious gas.

15. The electrical system according to claim 14, characterized in that the reference gas pressure in the reference volume is 2.5-45% higher than the filling pressure.
